(19) United States
(12) Patent Application Publication
(10) Pub. No.: US 2026/0120639 A1
(43) Pub. Date: Apr. 30, 2026

(54) DISPLAY PANEL AND DISPLAY DEVICE

(71) Applicant: HKC CORPORATION LIMITED, Baoan District (CN)

(72) Inventors: Xiufeng ZHOU, Shenzhen (CN); Xin YUAN, Shenzhen (CN); Chen CHEN, Shenzhen (CN); Haijiang YUAN, Shenzhen (CN)

(21) Appl. No.: 19/366,620

(22) Filed: Oct. 23, 2025

(30) Foreign Application Priority Data
Oct. 31, 2024 (CN) 202411549610.7

(51) Int. Cl. G09G 3/3233

(52) U.S. Cl. CPC G09G 3/3233; G09G 2300/043; G09G 2300/0819; G09G 2300/0852; G09G 2310/08

(57) ABSTRACT

Disclosed are a display panel and a display device. The display panel includes multiple pixel units arranged in an array. Each of the multiple pixel units includes a driving module, an adjusting module, a maintaining module, and a light-emitting module. The adjusting module is electrically connected to the driving module, and the driving module is electrically connected to the maintaining module and the light-emitting module. The adjusting module is configured to adjust a threshold voltage of a driving switch transistor in the driving module to be in a predetermined range, the maintaining module is configured to maintain a voltage of the driving module in a data writing phase, and the driving switch transistor is configured to drive the light-emitting module to emit corresponding light according to the data signal to execute image display.

### CROSS-REFERENCE TO RELATED APPLICATIONS

This application claims priority to Chinese Patent Application No. 202411549610.7, filed Oct. 31, 2024, the entire disclosure of which is incorporated herein by reference.

### TECHNICAL FIELD

The present disclosure relates to the field of display technology, and in particular, to a display panel and a display device.

### BACKGROUND

An organic light-emitting diode (OLED) display device has the advantages of self-illumination, low driving current, high luminous efficiency, short response time, high clarity and contrast, a viewing angle close to 180° C., a wide temperature range for application, and flexible display and large-area full-color display, etc., and is considered to be the most promising display device in the industry. However, since the light-emitting material of the OLED is driven by a current to emit light, as panel sizes increase, in order to reduce the heating of the large-size OLED panel, the current for driving the light-emitting material of the OLED needs to be as small as possible, and in this case, the transistor for controlling the driving current is likely to have threshold voltage variation which lead to inconsistent driving current passing through the transistor under the control of the same data voltage, which results in different light emitting intensities of the OLED, and leads to a poor display effect of the display panel.

Therefore, how to adjust and compensate the threshold voltage variation to improve the display effect is an urgent problem to be solved.

### SUMMARY

A display panel is provided in embodiments of the present disclosure. The display panel includes multiple pixel units arranged in an array, and the multiple pixel units each is configured to execute image display according to a received data signal. Each of the multiple pixel units includes a driving module, an adjusting module, a maintaining module, and a light-emitting module. The adjusting module is electrically connected to the driving module, and the driving module is electrically connected to the maintaining module and the light-emitting module. The adjusting module is configured to adjust a threshold voltage of a driving switch transistor in the driving module to be in a predetermined range, the maintaining module is configured to maintain a voltage of the driving module in a data writing phase, and the driving switch transistor is configured to drive the light-emitting module to emit corresponding light according to the data signal to execute image display.

Embodiments of the present disclosure further provide a display device. The display device includes a power supply module and a display panel. The power supply module is configured to supply driving power for the display panel to drive the display panel to execute image display. The display panel includes multiple pixel units arranged in an array, and the multiple pixel units each is configured to execute image display according to a received data signal. Each of the multiple pixel units includes a driving module, an adjusting module, a maintaining module, and a light-emitting module. The adjusting module is electrically connected to the driving module, and the driving module is electrically connected to the maintaining module and the light-emitting module. The adjusting module is configured to adjust a threshold voltage of a driving switch transistor in the driving module to be in a predetermined range, the maintaining module is configured to maintain a voltage of the driving module in a data writing phase, and the driving switch transistor is configured to drive the light-emitting module to emit corresponding light according to the data signal to execute image display.

### BRIEF DESCRIPTION OF THE DRAWINGS

To describe technical solutions of embodiments of the present disclosure more clearly, the following will give a brief introduction to accompanying drawings used for describing embodiments. Apparently, the accompanying drawings hereinafter described are some embodiments of the disclosure. Based on these drawings, those of ordinary skill in the art can also obtain other drawings without creative effort.

FIG. 1 is a structural schematic diagram of a display device provided in a first embodiment of the present disclosure;

FIG. 2 is a planar layout schematic diagram of a display panel in FIG. 1.

FIG. 3 is a schematic diagram of an equivalent circuit of a pixel unit in FIG. 2.

FIG. 4 is a timing diagram of signals output in FIG. 3.

FIG. 5 is a schematic diagram illustrating a change of a turn-on curve of a driving switch transistor in FIG. 3.

FIG. 6 is a timing diagram of signals output in a first compensation mode of the pixel unit in FIG. 3.

FIG. 7 is a timing diagram of signals output in a second compensation mode of the pixel unit in FIG. 3.

### DESCRIPTION OF REFERENCE SIGNS

display device—100, display panel—10, display region—10a, array substrate—10c, power supply module—20, m data lines—S1-Sm, n scan lines—G1-Gn, first direction—F1, second direction—F2, timing control circuit—11, data driving circuit—12, scan driving circuit—13, pixel unit—15, driving module—151, control module—152, adjusting module—153, storage module—154, light—emitting module—155, first signal-receiving—module—156, second signal-receiving—module—157, maintaining module—158, first node—N1, second node—N2, third node—N3, fourth node—N4, driving switch transistor—DT, first switch transistor—T1, second switch transistor—T2, third switch transistor—T3, fourth switch transistor—T4, fifth switch transistor—T5, sixth switch transistor—T6, first capacitor—C1, second capacitor—C2, light—emitting element—E, scan line—G, data line—S, control signal terminal—EM, adjustment signal terminal—K, first reference voltage terminal—ER1, second reference voltage terminal—ER2, driving voltage terminal—VDD, low voltage terminal—VSS, first time period—t1, second time period—t2, third time period—t3, fourth time period—t4, and data signal—Data.

### DETAILED DESCRIPTION

In order to facilitate understanding of the present disclosure, a detailed description will now be given with reference to relevant accompanying drawings. The accompanying drawings illustrate some examples of implementations of the present disclosure. However, the present disclosure can be implemented in many different forms and is not limited to the implementations described herein. On the contrary, these embodiments are provided for a more thorough and comprehensive understanding of the present disclosure.

The following description of the embodiments refers to the accompanying drawings to illustrate specific embodiments of the present disclosure. Sequential references assigned to components in the description, such as “first”. “second”, etc., are used merely to distinguish between described objects and do not have any ordinal or technical meaning. However, the expressions “connected” and “coupled” in the present disclosure, unless otherwise specified, both include direct connection and indirect connection. Directional terms mentioned in the present disclosure, for example, “upper”, “lower”, “front”, “rear”, “left”, “right”, “inner”, “outer”, “side”, or the like are only directions with reference to the accompanying drawings, and therefore, the directional terms are used for better and clearer illustration and understanding of the present disclosure, rather than indicate or imply that the indicated device or element must have a particular orientation or be constructed and operated in a particular orientation. Therefore, it cannot be understood that the present disclosure is limited thereto.

In description of the present disclosure, it should be noted that, unless stated otherwise, terms “installing”, “coupling”, and “connecting” referred to herein should be understood in broader sense. For example, they may include a fixed coupling, a removable coupling, or an integrated coupling; they may include a mechanical coupling or an electrical coupling; they may include a direct coupling, an indirect coupling through a medium, or an interconnection between two components, or an interaction coupling between two components. For those of ordinary skill in the art, the above terms in the present disclosure can be understood according to specific situations. The terms “first”, “second”, and the like used in the specification, the claims, and the accompany drawings of the disclosure are used to distinguish different objects rather than describe a particular order.

Additionally, as used herein, the term “including”, “may include”, “including”, or “may include” indicates the existence of corresponding functions, operations, elements, etc. that are disclosed, and does not limit one or more other functions, operations, elements, etc. In addition, the terms “include” or “include” means that there are corresponding features, numbers, steps, operations, elements, components, or a combination thereof disclosed in the description, and do not exclude the presence or addition of one or more other features, numbers, steps, operations, elements, components, or a combination thereof, and are intended to cover a non-exclusive inclusion. In addition, when describing embodiments of the present disclosure, “can” is used to mean “one or more embodiments of the present disclosure”. Also, the term “exemplary” is intended to mean examples or illustrations.

Unless otherwise defined, all technical and scientific terms used herein have the same meaning as commonly understood by those skilled in the art of the present disclosure. The terms used herein in the disclosure are for the purpose of describing implementations only and are not intended to limit the disclosure.

In view of the limitations associated with the aforementioned technical issues, the present disclosure provides a display panel and a display device capable of effectively adjusting a threshold voltage of a driving transistor.

In comparison with the related art, in embodiments of the present disclosure, a threshold voltage of a driving switch transistor in a pixel unit is adjusted to be in a predetermined range before a data signal is written. As a result, the problem that light emitting intensities of adjacent pixel units are different due to a threshold voltage difference is effectively eliminated, and a reset voltage is transmitted to a driving module through a maintaining module in a signal writing phase to perform resetting, so that a voltage of the driving switch transistor is effectively maintained to be stable, thereby avoiding the influence on the adjustment of the threshold voltage caused by the voltage variation. Furthermore, since the threshold voltage is adjusted before the data signal is written, no signal for compensating for the threshold voltage of the driving switch transistor needs to be additionally provided when the data signal is input. Thus, the load of the data line is effectively reduced, the transmission efficiency of the data signal is improved, and the transmission range of the data signal is improved. As a result, the transmission of the data signal is avoided to be compressed due to the compensation of the threshold voltage, and the display effect of the pixel unit is further improved.

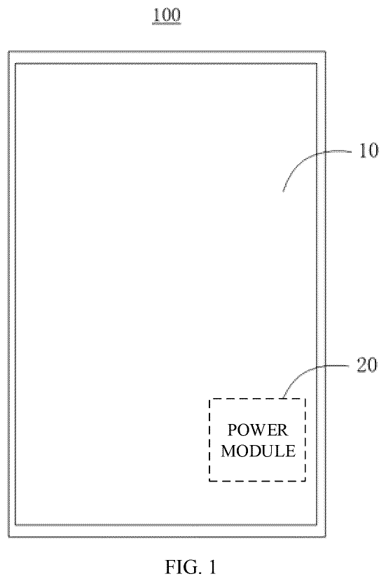

Reference is made to FIG. 1, which is a schematic structural diagram of a display device 100 provided in a first embodiment of the present disclosure. The display device 100 includes a display panel 10 and a power module 20, with the power module 20 disposed on the backside of the display panel 10, i.e., the non-display surface of the display panel 10. The power module 20 is configured to provide a driving current for image display on the display panel 10.

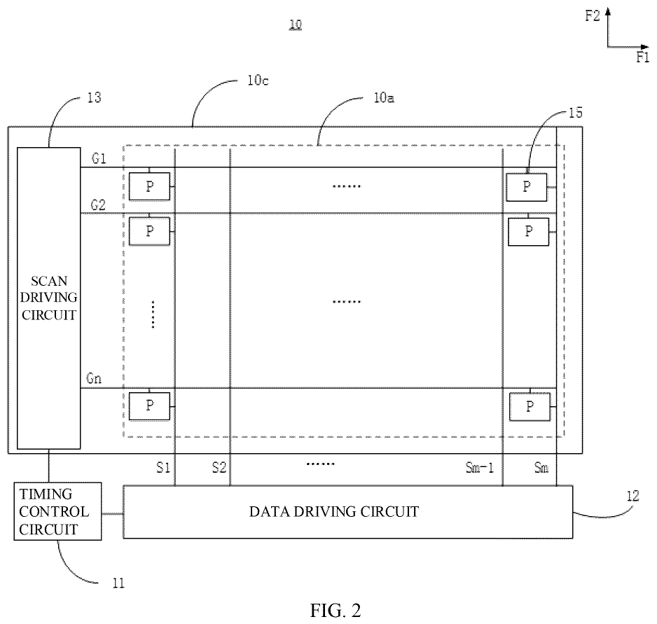

Reference is made to FIG. 2, which is a planar layout schematic diagram of the display panel in FIG. 1.

As illustrated in FIG. 2, the display panel 10 includes, in a display region, multiple pixel units 15 arranged in a matrix, m data lines S1-Sm, and n scan lines G1-Gn where m and n are natural numbers greater than 1.

The n scan lines G1-Gn each extend along a first direction F1 and are arranged parallel to each other along a second direction F2 and are insulated from each other. The m data lines S1-Sm each extend along the second direction F2 and are arranged parallel to each other along the first direction F1 and are insulated from each other. The first direction F1 and the second direction F2 are perpendicular to each other.

The display panel 10 includes, in the non-display region, a timing control circuit 11 a data driving circuit 12, and a scan driving circuit 13 disposed on the array substrate 10c, for driving the pixel units to execute image display.

The timing control circuit 11 is electrically connected to the data driving circuit 12 and the scan driving circuit 13 and is configured to control the operation timing of the data driving circuit 12 and the scan driving circuit 13, i.e., to output corresponding timing light-emitting signals to the data driving circuit 12 and the scan driving circuit 13 to control when to output corresponding scan signals and data signals.

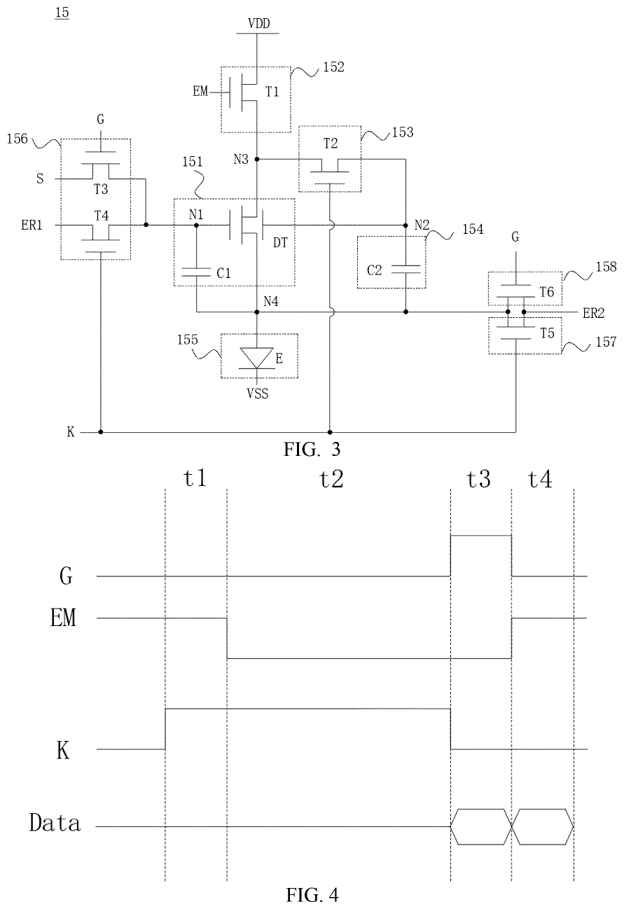

The data driving circuit 12 is electrically connected to the m data lines S1-Sm and is configured to transmit data signals (Data) to the multiple pixel units 15 in the form of data voltages through the m data lines S1-Sm for display. The data driving circuit 12 is further electrically connected to a first reference voltage terminal ER1 (FIG. 3) and a second reference voltage terminal ER2 (FIG. 3) in the pixel unit 15, and is configured to provide a first reference signal and a second reference signal for the pixel unit 15.

The scan driving circuit 13 is electrically connected to the n scan lines G1-Gn, and is configured to output scan signals through the n scan lines G1-Gn to control when the pixel units 15 receive data signals. In some embodiments, the scan driving circuit 13 may output scan signals to the n scan lines G1-Gn sequentially according to a positional order of the n scan lines G1-Gn and a scan cycle, and of course may also perform scanning in other orders according to specific requirements, for example, sequentially output scan signals to G1, G3 and G5, which is not limited in the present disclosure.

Reference is made to FIG. 3, which is schematic diagram of an equivalent circuit of the pixel unit in FIG. 2.

As illustrated in FIG. 3, the pixel unit 15 includes a driving module 151, a control module 152, an adjusting module 153, a storage module 154, and a light-emitting module 155, The adjusting module 153 is electrically connected to the driving module 151, the control module 152, and the storage module 154. The control module 152 is further electrically connected to a driving voltage terminal VDD. The driving module 151 is further electrically connected to the light-emitting module 155. The control module 152 is configured to control the driving voltage terminal VDD to charge the storage module 154. The storage module 154 is configured to cooperate with the adjusting module 153 to adjust a threshold voltage of the driving module 151, so as to adjust the threshold voltage of the driving module 151 to be within a predetermined range. The driving module 151 is configured to drive the light-emitting module 155 to emit light.

The threshold voltage of the driving module 151 of the pixel unit 15 can be directly adjusted to be in a predetermined range by providing the adjusting module 153 and the storage module 154. Therefore, threshold voltages of the driving modules 151 in adjacent pixel units 15 may be adjusted to be in the same predetermined range, which can eliminate the difference in light emitting intensities of adjacent pixel units caused by different threshold voltages of the driving modules 151, avoid the brightness difference between adjacent pixel units 15, and improve the display effect effectively.

In the present embodiment, the pixel unit 15 further includes a first signal-receiving-module 156, a second signal-receiving-module 157, and a maintaining module 158. The first signal-receiving-module 156 is electrically connected to the data line S, the first reference voltage terminal ER1, and the driving module 151. The first signal-receiving-module 156 is configured to receive the data signal from the data line S or receive a first reference signal from the first reference voltage terminal ER1, and transmits the data signal or the first reference signal to the driving module 151. The second signal-receiving-module 157 is electrically connected to an adjustment signal terminal K, the second reference voltage terminal ER2, and a fourth node N4. The second signal-receiving-module 157 is configured to receive a second reference signal from the second reference voltage terminal ER2 under the control of the adjustment signal terminal K and transmit the second reference signal to the fourth node N4. The maintaining module 158 is electrically connected to the second reference voltage terminal ER2, the scan line G, and the fourth node N4. The maintaining module 158 is configured to receive the second reference signal from the second reference voltage terminal ER2 under the control of a scan signal and transmit the second reference signal to the fourth node N4 as a reset signal, to reset the fourth node N4.

The first reference signal and the second reference signal are used in conjunction with the adjusting module 153 to adjust the threshold voltage of the driving module 151, and the data signal is provided to the driving module 151 in an image display phase, so that the driving module 151 drives the light-emitting module 155 to emit light according to the data signal.

The pixel unit 15 further includes a first node N1, a second node N2, a third node N3, and the fourth node N4. The first signal-receiving-module 156 is electrically connected to a first control terminal of the driving module 151 through the first node N1. The second node N2 is electrically connected to a second control terminal of the driving module 151, the adjusting module 153, and the storage module 154, in other words, the adjusting module 153 is electrically connected to the storage module 154 through the second node N2. The adjusting module 153 is further electrically connected to the third node N3 and electrically connected to the driving module 151 and the control module 152 through the third node N3. The second signal-receiving-module 157 is electrically connected to the fourth node N4 and electrically connected to the storage module 154, the driving module 151, and the light-emitting module 155 through the fourth node N4. The second signal-receiving-module 157 is configured to provide the second reference signal to the driving module 151 through the fourth node N4, where a voltage of the second reference signal is insufficient to drive the light-emitting module 155 to emit light.

In an initialization phase, the control module 152 is configured to control the driving voltage terminal VDD to charge the second node N2 to a first potential through the adjusting module 153, and the storage module 154 is configured to store charges of the second node N2 and maintain a potential of the second node N2. In a compensation phase, the second node N2 is configured to discharge to the fourth node N4 through the adjusting module 153 and the driving module 151, to adjust a threshold voltage of the driving module 151 to a predetermined value. The initialization phase and the compensation phase are two continuous phases. In a data writing phase, the first signal-receiving-module 156 receives the data signal and transmits the data signal to the first node N1, meanwhile, the maintaining module 158 receives the second reference signal and transmits the second reference signal to fourth node N4 to control the fourth node N4 to maintain at the second reference potential. In an image display phase, the control module 152 is configured to control the driving voltage terminal VDD to output a driving voltage to the driving module 151 through the third node N3, and the driving module 151 is configured to control the driving voltage according to the received data signal to drive the light-emitting module 155 to emit light.

Specifically, the driving module 151 includes a driving switch transistor DT and a first capacitor C1. A first control terminal of the driving switch transistor DT is electrically connected to the first node N1, a second control terminal of the driving switch transistor DT is electrically connected to the second node N2, and a first conductive terminal of the driving switch transistor DT is electrically connected to the third node N3, and a second conductive terminal of the driving switch transistor DT is electrically connected to the fourth node N4 and electrically connected to the light-emitting module 155 through the fourth node N4. That is, the driving switch transistor DT is a double-gate transistor having the first control terminal and the second control terminal. The first capacitor C1 is electrically connected between the first node N1 and the fourth node N4, that is, electrically connected between the first control terminal and the second conductive terminal of the driving switch transistor DT. The driving switch transistor DT is configured to be turned on under the control of the first control terminal and/or the second control terminal, receive a driving current from the control module 152, and drive the light-emitting module 155 to emit light according to the driving current.

The control module 152 includes a first switch transistor T1. A control terminal of the first switch transistor T1 is electrically connected to a control signal terminal EM, a first conductive terminal of the first switch transistor T1 is electrically connected to the driving voltage terminal VDD, a second conductive terminal of the first switch transistor T1 is electrically connected to the third node N3 and is electrically connected to the adjusting module 153 and the first conductive terminal of the driving switch transistor DT through the third node N3. The first switch transistor T1 is configured to be turned on upon receiving a control signal, to transmit the driving voltage output from the driving voltage terminal VDD to the adjusting module 153 or to the first conductive terminal of the driving switch transistor DT.

The adjusting module 153 includes a second switch transistor T2. A control terminal of the second switch transistor T2 is electrically connected to the adjustment signal terminal K, a first conductive terminal of the second switch transistor T2 is electrically connected to the second node N2, a second conductive terminal of the second switch transistor T2 is electrically connected to the third node N3 and is electrically connected to the first conductive terminal of the driving switch transistor DT through the third node N3. The second switch transistor T2 is configured to be turned on under the control of an adjustment signal outputted from the adjustment signal terminal K, to control the second node N2 to be electrically connected to the first conductive terminal of the driving switch transistor DT. Since the second node N2 is also electrically connected to the second control terminal of the driving switch transistor DT, when the second node N2 is at the first potential, the driving switch transistor DT is turned on, so that the second node N2, the second switch transistor T2, the third node N3, and the driving switch transistor DT form a discharge path, and thus the second node N2 may discharge to the driving switch transistor DT.

The storage module 154 includes a second capacitor C2. A first terminal of the second capacitor C2 is electrically connected to the second node N2, and a second terminal of the second capacitor C2 is electrically connected to the fourth node N4. The second capacitor C2 is configured to store charges when the driving voltage terminal VDD charges the second node N2, and maintain the second node N2 at the first potential.

The light-emitting module 155 includes a light-emitting element E, and the light-emitting element E may be an organic light-emitting diode. An anode of the light-emitting element E is electrically connected to the fourth node N4, and a cathode of the light-emitting element E is electrically connected to a low voltage terminal VSS. The light-emitting module 155 is configured to emit light according to a driving current transmitted by the driving switch transistor DT.

The first signal-receiving-module 156 includes a third switch transistor T3 and a fourth switch transistor T4. A control terminal of the third switch transistor T3 is electrically connected to the scan line G, a first conductive terminal of the third switch transistor T3 is electrically connected to the data line S, and a second conductive terminal of the third switch transistor T3 is electrically connected to the first node N1. The third switch transistor T3 is configured to receive the data signal from the data line S and transmit the data signal to the first node N1 under the control of the scan signal. A control terminal of the fourth switch transistor T4 is electrically connected to the adjustment signal terminal K, a first conductive terminal of the fourth switch transistor T4 is electrically connected to the first reference voltage terminal ER1, and a second conductive terminal of the fourth switch transistor T4 is electrically connected to the first node N1. The fourth switch transistor T4 is configured to be turned on under the control of the adjustment signal output by the adjustment signal terminal K, to control the first reference voltage terminal ER1 to output the first reference signal to the first node N1.

The second signal-receiving-module 157 includes a fifth switch transistor T5. A control terminal of the fifth switch transistor T5 is electrically connected to the adjustment signal terminal K, a first conductive terminal of the fifth switch transistor T5 is electrically connected to the second reference voltage terminal ER2, and a second conductive terminal of the fifth switch transistor T5 is electrically connected to the fourth node N4. The fifth switch transistor T5 is configured to receive the second reference signal from the second reference voltage terminal ER2 under the control of the adjustment signal and transmit the second reference signal to the fourth node N4.

The maintaining module 158 includes a sixth switch transistor T6. A control terminal of the sixth switch transistor T6 is electrically connected to the scan line G, a first conductive terminal of the sixth switch transistor T6 is electrically connected to the second reference voltage terminal ER2, and a second conductive terminal of the sixth switch transistor T6 is electrically connected to the fourth node N4. The sixth switch transistor T6 is configured to be turned on under the control of the scan signal to control the second reference voltage terminal ER2 to output the second reference signal in the data writing phase and transmit the second reference signal to the fourth node N4, and configured to maintain the fourth node N4 at the second reference potential. The sixth switch transistor T6 and the third switch transistor T3 are connected to the same scan line, to save wiring space.

In this embodiment, the driving switch transistor DT is a dual-gate transistor, in which the first control terminal and the second control terminal may be gates, the first conductive terminal may be a drain, the second conductive terminal may be a source. For each of the first to fourth switch transistors T1 to T4, the control terminal of may be a gate, the first conductive terminal may be a source, and the second conductive terminal may be a drain. Of course, the above settings may also be adjusted correspondingly according to specific requirements, which is not limited thereto in the present disclosure.

Reference is made to FIG. 3 and FIG. 4, where FIG. 4 is a timing diagram of signals output in FIG. 3.

As illustrated in FIG. 4, in a first time period t1 which is the initialization phase, the control signal terminal EM controls the first switch transistor T1 to be turned on, meanwhile, the adjustment signal terminal K outputs an adjustment signal to control the second switch transistor T2, the fourth switch transistor T4, and the fifth switch transistor T5 to be turned on, and to control driving voltage terminal VDD to charge the second node N2 to the first potential through the first switch transistor T1 and the second switch transistor T2. In other words, the voltage of the second node N2 is charged to VDD. The first reference voltage terminal ER1 outputs the first reference signal to the first node N1 through the fourth switch transistor T4, and the second reference voltage terminal ER2 outputs the second reference signal to the fourth node N4 through the fifth switch transistor T5. V_{ER2}<VSS+Vel, where VSS refers to the voltage at the low voltage terminal, and Vel refers to the voltage for driving the light-emitting element E to emit light. In other words, the second reference signal transmitted to the fourth node N4 is insufficient to drive the light-emitting element E to emit light.

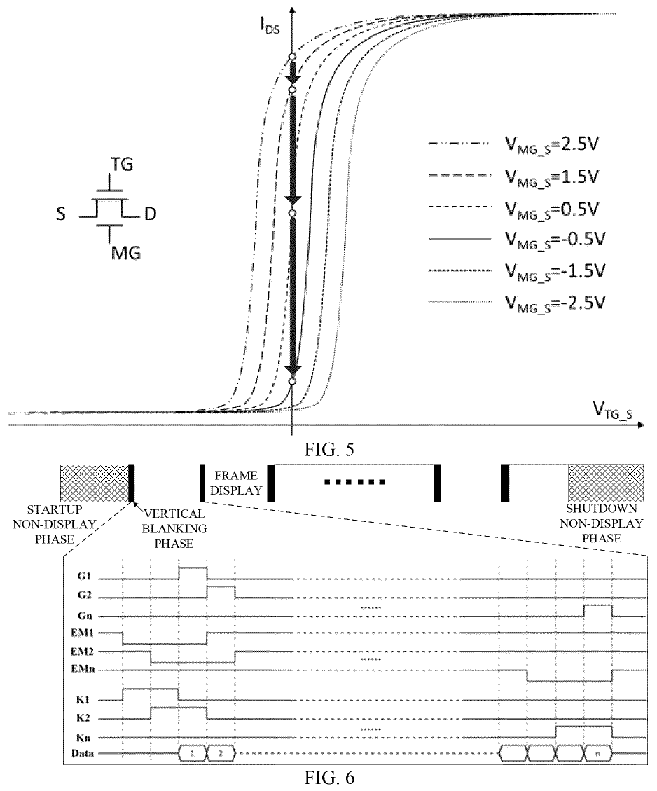

A second time period t2 is the compensation phase. In the second time period t2, the control signal terminal EM controls the first switch transistor T1 to be turned off, and the driving switch transistor DT is turned on under the control of the first node N1 and the second node N2. The second node N2, the second switch transistor T2, the driving switch transistor DT, and the fourth node N4 form a discharge path, the second node N2 discharges to the fourth node N4 through the second switch transistor T2 and the driving switch transistor DT, and the second node N2 gradually decreases from the first potential to the second potential, until the driving switch transistor DT is turned off. As illustrated in FIG. 5, FIG. 5 is a schematic diagram illustrating a change of a turn-on curve of the driving switch transistor in FIG. 3. V_{TG_S} is a voltage difference between the first control terminal and the second conductive terminal of the driving switch transistor DT, i.e., a voltage difference between the first gate and the source, i.e., a voltage difference between the first node N1 and the fourth node N4. V_{MG_S} is a voltage difference between the second control terminal and the second conductive terminal of the driving switch transistor DT, i.e., a voltage difference between the second gate and the source, i.e., a voltage difference between the second node N2 and the fourth node N4. Ips is a magnitude of a current flowing through the driving switch transistor DT. The discharging process will be described in detail below with reference to a curve in a case that V_{MG_S}=2.5V. At the start of the second time period t2, supposing that V_{MG_S}=2.5V (V_{N2}−V_{N4}=2.5V) and V_{TG_S}=0V (V_{N1}−V_{N4}=0V), I_{DS}>0, the driving switch transistor DT is in a turn-on state. With the progress of the second time period t2, the second node N2 discharges to the driving switch transistor DT through the second switch transistor T2 and the third node N3, so that the voltage of the second node N2 gradually decreases and the voltage of the fourth node N4 remains unchanged, and at this time, the voltage difference (V_{MG_S}) between the second node N2 and the fourth node N4 gradually decreases. After the voltage of the second node N2 drops to be less than the voltage of the fourth node N4, the voltage difference (V_{MG_S}) between the second node N2 and the fourth node N4 gradually increases. That is to say, reference of the whole discharging process can be made to the arrows on the vertical axis, V_{TG_S} is unchanged, and at the same time, V_{MG_S} gradually decreases and then gradually increases. In this process, Ips gradually decreases, and when the voltage of the second node N2 decreases to the predetermined voltage V_{MG}, i.e., the second potential, so that the Ips can be ignored, the driving switch transistor DT can be considered to be turned off. The critical voltage at which the driving switch transistor DT transitions between turn-on and turn-off is the threshold voltage Vih. That is, when the voltage of the second node N2 or the second control terminal of the driving switch transistor DT is the predetermined voltage V_{MG}, the voltage difference (V_{TG_S}) between the first control terminal and the source of the driving switch transistor DT is equal to the threshold voltage Vₜₕ of the driving switch transistor DT. In this embodiment, Vₜₕ=V_{TG_S}=0. In other embodiments, V_{TG_S} (V_{N1}−V_{N4}) may be set to be other values in the first time period t1, and since V_{TG_S} remains unchanged in the second time period t2, correspondingly, the threshold voltage Vith may also be other values. That is, the threshold voltage Vₜₕ may be set according to specific requirements, which is not limited in the present disclosure.

In a third time period t3, the second switch transistor T2, the fourth switch transistor T4, and the fifth switch transistor T5 are turned off, and the second capacitor C2 is configured to maintain a voltage difference between the second node N2 and the fourth node N4 at this moment, meanwhile, the scan signal controls the third switch transistor T3 and the sixth switch transistor T6 to be turned on. The data line S outputs a data voltage V_{Data} (data signal) to the first node N1 through the third switch transistor T3, meanwhile, the second reference voltage terminal ER2 outputs the second reference signal to the fourth node N4 through the sixth switch transistor T6. At this time, V_{TG_S}=V_{N1}−V_{N4}=V_{Data}−V_{ER2}, that is, the voltage difference between the first control terminal and the second conductive terminal of the driving switch transistor DT is equal to the difference between the data signal and the second reference signal. By controlling the second reference voltage terminal ER2 to be electrically connected to the fourth node N4 when the data signal is input, that is, controlling the fourth node N4 to be maintained at the second reference potential, the problem of poor image display effect caused by the change of the voltage of the fourth node N4 is avoided.

In embodiments of the present disclosure, the third switch transistor T3 and the sixth switch transistor T6 are controlled to be turned on and turned off at the same time by the scan line G, and the fourth switch transistor T4 and the fifth switch transistor T5 are controlled to be turned on and turned off at the same time by the adjustment signal terminal K, so that the arrangement of signal lines for transmitting adjustment signals can be effectively simplified, the space occupation is reduced, and the line layout is optimized.

In a fourth time period t4, the scan line G stops transmitting the scan signal, so as to control the third switch transistor T3 to be turned off, and the input voltage V_{Data} written by the data line S is transmitted to the first node N1 and stored in the first capacitor C1, in other words, the first capacitor C1 maintains the voltage of the first node N1. Meanwhile the control signal terminal EM controls the first switch transistor T1 to be turned on, a path is formed between the driving voltage terminal VDD and the low voltage terminal VSS, the driving switch transistor DT and the light-emitting element E perform voltage division, the voltage of the fourth node N4 is increased to V_{E}+V_{SS} to drive the light-emitting element E to emit light, where V_{E} is a voltage for driving the light-emitting element E to emit light. While the voltage of fourth node N4 is increased, the voltage of the first node N1 is increased to V_{Data}+V_{E}+VSS−V_{ER2} due to the coupling of the first capacitor C1, the voltage of the second node N2 is increased to V_{MG}+V_{E}+VSS−V_{ER2} due to the coupling of the second capacitor C2. At this time, the current passing through the light-emitting element is I=(k/2) (V_{TG_S}−Vₜₕ)²=(k/2)[(1−α) (V_{Data}−V_{ER2}−Vₜₕ)]². Since Vₜₕ is set to 0V in the second time period t2, I=(k/2)[(1−α)(V_{Data}−V_{ER2})]², where k=W·Cₒₓ·μ_{eff}/L; W represents a channel width of a discrete-time Fourier transform (DTFT) device, L represents a channel length of the DTFT device, Cₒₓ represents a capacitance per unit area of a gate dielectric layer, and μ_{eff} represents a mobility of semiconductor material in a channel region.

In the initialization phase (the first time period t1) and the compensation phase (the second time period t2), the first reference signal written by the first reference voltage terminal can be set according to specific requirements. If the written voltage is VN, the threshold voltage Vₜₕ of the driving switch transistor satisfies Vₜₕ−Vx−V_{ER2}, under the control of the predetermined voltage V_{MG}. That is, the voltage VN written by the first reference voltage terminal ER1 is adjusted in the initialization phase and the compensation phase, and the discharging process of the second node N2 is controlled in the compensation phase, so that an IDVG curve (FIG. 4) of the first switch transistor T1 can be adjusted for offset, so as to adjust the threshold voltage. If V_{X}=V_{ER2}, then the threshold voltage Vₜₕ=0. Of course. VN can also be set to be other values, and thus the threshold voltage can also be set to be other values.

Reference is made to FIG. 6, which is a timing diagram of signals output in a first compensation mode of the pixel unit illustrated in FIG. 3.

As illustrated in FIG. 6, when the display panel 10 is in the first compensation mode, during display of each frame of image, n scan lines sequentially output scan signals. Meanwhile, the adjustment signal terminal K, the control signal terminal EM, the first reference signal terminal ER1, and the second reference signal terminal ER2 output signals according to a predetermined timing for adjusting the threshold voltage Vₜₕ of the driving switch transistor DT in the pixel unit 15, that is, the threshold voltage Vₜₕ is compensated, and then data writing and light emission are performed. In other words, the pixel unit 15 sequentially executes the process from the first time period t1 to the fourth time period t4 during display of each frame of image (display frames), and compensation is performed line by line.

The first reference signal is transmitted to the first node N1 through the fourth switch transistor T4 in the initialization phase and the compensation phase, the data signal is transmitted to the first node N1 through the third switch transistor T3 in the data writing phase, that is, the data signal and the first reference signal are transmitted respectively through two independent lines, so that in the compensation process line by line, when the data signal is written into the pixel units in a previous row during the data writing phase, a next row of pixel units can be controlled to execute the initialization phase and the compensation phase, so that the time of inputting the first reference signal to the next row of pixel units partially overlaps with the data writing phase of the previous row of pixel units, so as to increase the compensation time. Furthermore, by providing the sixth switch transistor T6, the fourth node N4 can also receive the second reference signal input by the second reference voltage terminal ER2 in the data writing phase, that is, the fourth node N4 can receive the second reference signal in all of the initialization phase, the compensation phase, and the data writing phase, which effectively improves the stability of adjusting the threshold voltage of the driving switch transistor.

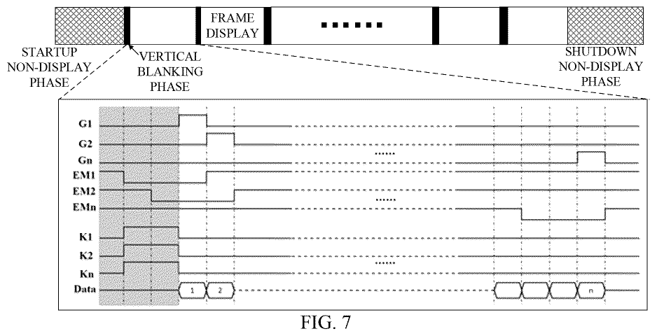

Reference is made to FIG. 7, which is a timing diagram of signals output in the second compensation mode of the pixel unit in FIG. 3.

As illustrated in FIG. 7, in the second compensation mode, in the non-image-display period, the pixel unit 15 executes the first period t1 and the second period t2 for adjusting the threshold voltage of the driving switch transistor DT, and in the image display period of each frame, the pixel unit 15 executes the third period t3 and the fourth period t4 for receiving a data signal and emitting light. The non-image-display period may be a startup non-display period and a vertical blanking phase between any two adjacent frames of images (display frames) of the display panel 10.

The first time period t1 and the second time period t2 are executed in the non-display period, the pixel units 15 on the entire surface of the display panel may be controlled to perform compensation at the same time, that is, entire-surface compensation is performed. Optionally, the first time period t1 and the second time period t2 are executed in a vertical blanking phase of each frame to perform entire-surface compensation, or the first time period t1 and the second time period t2 are executed once in a vertical blanking phase of every a frames, where a is an integer greater than 1. In other words, in the non-image-display phase, the first period t1 and the second period t2 may be executed, to complete the process of setting the threshold voltage of the driving switch transistor DT. In this way, in the display phase, the first time period t1 and the second time period t2 do not need to be executed, and the third period t3 and the fourth period t4 are executed, thereby completing the data writing and light-emitting processes, and effectively increasing the compensation time. In other words, in the threshold compensation phase, the threshold voltages of the driving switch transistors DT of different pixel units in the display panel will be readjusted to a fixed value (for example, 0V), and this voltage is stored in the second capacitor C2, thus it is not necessary to perform compensation for each frame in practical use. Additionally, since the waveforms of the adjustment signals for controlling the respective rows of pixel units are consistent, there is no need to design a circuit for generating the adjustment signals.

A threshold voltage compensation range is also increased in embodiments of the present disclosure. The specific principle is as follows. It can be seen from the foregoing current formula that I=(k/2)(V_{TG_S}−Vₜₕ)². In embodiments of the present disclosure, after the compensation phase and the data writing phase, V_{TG_S}=V_{Data}−V_{ER}, that is to say, V_{TG_S} does not include Vₜₕ. However, with regard to a traditional solution that the driving transistor has a single gate, after the compensation phase and the data writing phase, V_{TG_S}=V_{Data}+Vₜₕ−Vint, where Vint can be understood as a reference voltage similar to V_{ER}, and V_{TG_S} (a voltage difference between a gate and a source) includes Vₜₕ. Due to the existence of Vₜₕ, the writing range of the data signal Data will be squeezed, thus the compensation range of Vₜₕ is limited to avoid the influence on the data range. However, in embodiments of the present disclosure, the V_{TG_S} does not include Vₜₕ, and therefore even if a range of Vₜₕ is set to be very large, the write range of the V_{Data} will not be compressed and occupied. In addition, in embodiments of the present disclosure, the pixel unit 15 can be compensated in a non-display period, so that the occupation of a display period is reduced, and the threshold voltage of the driving module 151 can be adjusted and compensated in the case of displaying multiple frames of images at intervals, thereby increasing the compensation time, so that the threshold voltage of the driving switch transistor is more fully compensated.

It should be understood that the application of the present disclosure is not limited to the above examples, and those skilled in the art can make improvements or modifications according to the above descriptions, and all these improvements and modifications shall belong to the scope of protection of the appended claims of the present disclosure.

What is claimed is:

1. A display panel, comprising a plurality of pixel units arranged in an array, the plurality of pixel units each being configured to execute image display according to a received data signal;
wherein each of the plurality of pixel units comprises a driving module, an adjusting module, a maintaining module, and a light-emitting module, the adjusting module is electrically connected to the driving module, and the driving module is electrically connected to the maintaining module and the light-emitting module; and wherein the adjusting module is configured to adjust a threshold voltage of a driving switch transistor in the driving module to be in a predetermined range, the maintaining module is configured to maintain a voltage of the driving module in a data writing phase, and the driving switch transistor is configured to drive the light-emitting module to emit corresponding light according to the data signal to execute image display.

2. The display panel of claim 1, wherein each of the plurality of pixel units further comprises a control module and a storage module, the control module is electrically connected to the adjusting module, the driving module, and a driving voltage terminal, and the storage module is electrically connected to the adjusting module; and
in an initialization phase, the control module is configured to control the driving voltage terminal to charge the storage module; and in a compensation phase, the adjusting module is configured to control the storage module to discharge to the driving module to adjust the threshold voltage of the driving module to be in the predetermined range, the initialization phase and the compensation phase being two continuous phases.

3. The display panel of claim 2, wherein the display panel further comprises a plurality of data lines and a plurality of scan lines, each of the plurality of pixel units is configured to receive a scan signal from one of the plurality of scan lines and receive the data signal from one of the plurality of data lines under the control of the scan signal; each of the plurality of pixel units further comprises a first signal-receiving-module and a second signal-receiving-module, the first signal-receiving-module is electrically connected to the one of the plurality of data lines, the one of the plurality of scan lines, the driving module, a first reference voltage terminal, and an adjustment signal terminal, the first signal-receiving-module is configured to receive the data signal from the one of the plurality of data lines under the control of the scan signal and transmit the data signal to the driving module, and receive a first reference signal from the first reference voltage terminal under the control of the adjustment signal terminal and transmit the first reference signal to the driving module; and
the second signal-receiving-module is electrically connected to the adjustment signal terminal, a second reference voltage terminal, and the driving module, and the second signal-receiving-module is configured to receive a second reference signal from the second reference voltage terminal under the control of the adjustment signal terminal and transmit the second reference signal to the driving module, wherein the first reference signal and the second reference signal are used in conjunction with the adjusting module to adjust the threshold voltage of the driving module.

4. The display panel of claim 3, wherein the driving module comprises a driving switch transistor and a first capacitor, the storage module comprises a second capacitor, and each of the plurality of pixel units further comprises a first node, a second node, a third node, and a fourth node, a first control terminal of the driving switch transistor is electrically connected to the first signal-receiving-module through the first node, a second control terminal of the driving switch transistor is electrically connected to the adjusting module and the storage module through the second node, a first conductive terminal of the driving switch transistor is electrically connected to the control module and the adjusting module through the third node, a second conductive terminal of the driving switch transistor is electrically connected to the light-emitting module through the fourth node, the first capacitor is electrically connected between the first node and the fourth node, and the second capacitor is electrically connected between the second node and the fourth node; and
in the initialization phase, the first reference voltage terminal is configured to output the first reference signal to the first node, the second reference voltage terminal is configured to output the second reference signal to the fourth node, and the driving voltage terminal is configured to charge the second node to a first potential to control the driving switch transistor to be turned on; and in the compensation phase, the second node is configured to discharge to the fourth node through the adjusting module and the driving switch transistor to adjust the threshold voltage of the driving switch transistor to a predetermined value, wherein the predetermined value is a difference between the first reference signal and the second reference signal.

5. The display panel of claim 4, wherein the control module comprises a first switch transistor and the adjusting module comprises a second switch transistor, a control terminal of the first switch transistor is electrically connected to a control signal terminal, a first conductive terminal of the first switch transistor is electrically connected to the driving voltage terminal, a second conductive terminal of the first switch transistor is electrically connected to the third node, a control terminal of the second switch transistor is electrically connected to the adjustment signal terminal, a first conductive terminal of the second switch transistor is electrically connected to the second node, and a second conductive terminal of the second switch transistor is electrically connected to the third node; and
in the initialization phase, the first switch transistor and the second switch transistor are configured to be turned on, the driving voltage terminal is configured to charge the second node through the first switch transistor and the second switch transistor, and in the compensation phase, the second node is configured to discharge to the fourth node through the second switch transistor and the driving switch transistor.

6. The display panel of claim 5, wherein the first signal-receiving-module comprises a third switch transistor and a fourth switch transistor, a control terminal of the third switch transistor is electrically connected to the one of the plurality of scan lines, a first conductive terminal of the third switch transistor is electrically connected to the one of the plurality of data lines, a second conductive terminal of the third switch transistor is electrically connected to the first node, and the third switch transistor is configured to receive the data signal from the one of the plurality of data lines under the control of the scan signal and transmit the data signal to the first node; and
a control terminal of the fourth switch transistor is electrically connected to the adjustment signal terminal, a first conductive terminal of the fourth switch transistor is electrically connected to the first reference voltage terminal, a second conductive terminal of the fourth switch transistor is electrically connected to the first node, and the fourth switch transistor is configured to be turned on under the control of the adjustment signal terminal to transmit the first reference signal to the first node.

7. The display panel of claim 6, wherein the second signal-receiving-module comprises a fifth switch transistor, the maintaining module comprises a sixth switch transistor, a control terminal of the fifth switch transistor is electrically connected to the adjustment signal terminal, a first terminal of the fifth switch transistor is electrically connected to the second reference voltage terminal, and a second terminal of the fifth switch transistor is electrically connected to the fourth node, and the fifth switch transistor is configured to receive the second reference signal from the second reference voltage terminal under the control of the adjustment signal terminal, and transmit the second reference signal to the fourth node;
a control terminal of the sixth switch transistor is electrically connected to the one of the plurality of scan lines, a first terminal of the sixth switch transistor is electrically connected to the second reference voltage terminal, a second conductive terminal of the sixth switch transistor is electrically connected to the fourth node, and the sixth switch transistor is configured to be turned on under the control of the scan signal, to control the second reference voltage terminal to output the second reference signal to the fourth node in the data writing phase, to maintain a voltage of the fourth node.

8. The display panel of claim 7, wherein,
in a first time period which is the initialization phase, the first switch transistor, the second switch transistor, the fourth switch transistor, and the fifth switch transistor are turned on, the third switch transistor, the sixth switch transistor, and the driving switch transistor are turned off, and the driving voltage terminal charges the second node to the first potential through the first switch transistor and the second switch transistor; meanwhile, the first reference voltage terminal outputs the first reference signal to the first node through the fourth switch transistor to control the first node to reset to a first reference potential, and the second reference voltage terminal outputs the second reference signal to the fourth node to control the second node to reset to a second reference potential;
in a second time period which is the compensation phase, the second switch transistor, the fourth switch transistor, and the fifth switch transistor are turned on, the first switch transistor, the third switch transistor, and the sixth switch transistor are turned off, the driving switch transistor is turned on under the control of the first node and the second node, the second node discharges to the fourth node through the second switch transistor and the driving switch transistor, the driving switch transistor is turned off in response to the second node dropping from the first potential to the second potential, and the threshold voltage of the driving switch transistor is adjusted to the predetermined value, wherein the second capacitor is configured to maintain a voltage of the second node;
in a third time period which is the data writing phase, the first switch transistor, the second switch transistor, the fourth switch transistor, and the fifth switch transistor are turned off, the third switch transistor and the sixth switch transistor are turned on, the data signal is transmitted to the first node through the third switch transistor, and the second reference signal is transmitted to the fourth node through the sixth switch transistor, wherein the first capacitor is configured to maintain a potential of the first node; and
in a fourth time period which is a light-emitting phase, the second switch transistor, the third switch transistor, the fourth switch transistor, the fifth switch transistor, and the sixth switch transistor are turned off, the first switch transistor is turned on; meanwhile, the data signal controls the driving switch transistor to be turned on, and the driving voltage terminal outputs a driving current to drive the light-emitting module to emit light.

9. The display panel of claim 8, wherein the first time period and the second time period are executed in a non-display phase, the third time period and the fourth time period are executed in an image display phase, and the non-display phase is a startup non-display phase.

10. The display panel of claim 8, wherein the first time period and the second time period are executed in a non-display phase, the third time period and the fourth time period are executed in an image display phase, the non-display phase is a vertical blanking phase, and the vertical blanking phase is located between image display phases of two adjacent frames;
the display panel is configured to execute the first period and the second period in the vertical blanking phase of each frame; or the display panel is configured to execute the first period and the second period once in the vertical blanking phase of every a frames, wherein a is an integer greater than 1.

11. The display panel of claim 8, wherein in an image display phase of each frame, each of the plurality of the pixel units is configured to sequentially execute the first period, the second period, the third period, and the fourth period.

12. A display device, comprising a power supply module and a display panel, wherein the power supply module is configured to supply driving power for the display panel to drive the display panel to execute image display;
wherein the display panel comprises a plurality of pixel units arranged in an array, and the plurality of pixel units each is configured to execute image display according to a received data signal; and
wherein each of the plurality of pixel units comprises a driving module, an adjusting module, a maintaining module, and a light-emitting module, the adjusting module is electrically connected to the driving module, and the driving module is electrically connected to the maintaining module and the light-emitting module; and wherein the adjusting module is configured to adjust a threshold voltage of a driving switch transistor in the driving module to be in a predetermined range, the maintaining module is configured to maintain a voltage of the driving module in a data writing phase, and the driving switch transistor is configured to drive the light-emitting module to emit corresponding light according to the data signal to execute image display.

13. The display device of claim 12, wherein each of the plurality of pixel units further comprises a control module and a storage module, the control module is electrically connected to the adjusting module, the driving module, and a driving voltage terminal, and the storage module is electrically connected to the adjusting module; and
in an initialization phase, the control module is configured to control the driving voltage terminal to charge the storage module; and in a compensation phase, the adjusting module is configured to control the storage module to discharge to the driving module to adjust the threshold voltage of the driving module to be in the predetermined range, the initialization phase and the compensation phase being two continuous phases.

14. The display device of claim 13, wherein the display panel further comprises a plurality of data lines and a plurality of scan lines, each of the plurality of pixel units is configured to receive a scan signal from one of the plurality of scan lines and receive the data signal from one of the plurality of data lines under the control of the scan signal; each of the plurality of pixel units further comprises a first signal-receiving-module and a second signal-receiving-module, the first signal-receiving-module is electrically connected to the one of the plurality of data lines, the one of the plurality of scan lines, the driving module, a first reference voltage terminal, and an adjustment signal terminal, the first signal-receiving-module is configured to receive the data signal from the one of the plurality of data lines under the control of the scan signal and transmit the data signal to the driving module, and receive a first reference signal from the first reference voltage terminal under the control of the adjustment signal terminal and transmit the first reference signal to the driving module; and
the second signal-receiving-module is electrically connected to the adjustment signal terminal, a second reference voltage terminal, and the driving module, and the second signal-receiving-module is configured to receive a second reference signal from the second reference voltage terminal under the control of the adjustment signal terminal and transmit the second reference signal to the driving module, wherein the first reference signal and the second reference signal are used in conjunction with the adjusting module to adjust the threshold voltage of the driving module.

15. The display device of claim 14, wherein the driving module comprises a driving switch transistor and a first capacitor, the storage module comprises a second capacitor, and each of the plurality of pixel units further comprises a first node, a second node, a third node, and a fourth node, a first control terminal of the driving switch transistor is electrically connected to the first signal-receiving-module through the first node, a second control terminal of the driving switch transistor is electrically connected to the adjusting module and the storage module through the second node, a first conductive terminal of the driving switch transistor is electrically connected to the control module and the adjusting module through the third node, a second conductive terminal of the driving switch transistor is electrically connected to the light-emitting module through the fourth node, the first capacitor is electrically connected between the first node and the fourth node, and the second capacitor is electrically connected between the second node and the fourth node; and
in the initialization phase, the first reference voltage terminal is configured to output the first reference signal to the first node, the second reference voltage terminal is configured to output the second reference signal to the fourth node, and the driving voltage terminal is configured to charge the second node to a first potential to control the driving switch transistor to be turned on; and in the compensation phase, the second node is configured to discharge to the fourth node through the adjusting module and the driving switch transistor to adjust the threshold voltage of the driving switch transistor to a predetermined value, wherein the predetermined value is a difference between the first reference signal and the second reference signal.

16. The display device of claim 15, wherein the control module comprises a first switch transistor and the adjusting module comprises a second switch transistor, a control terminal of the first switch transistor is electrically connected to a control signal terminal, a first conductive terminal of the first switch transistor is electrically connected to the driving voltage terminal, a second conductive terminal of the first switch transistor is electrically connected to the third node, a control terminal of the second switch transistor is electrically connected to the adjustment signal terminal, a first conductive terminal of the second switch transistor is electrically connected to the second node, and a second conductive terminal of the second switch transistor is electrically connected to the third node; and
in the initialization phase, the first switch transistor and the second switch transistor are configured to be turned on, the driving voltage terminal is configured to charge the second node through the first switch transistor and the second switch transistor, and in the compensation phase, the second node is configured to discharge to the fourth node through the second switch transistor and the driving switch transistor.

17. The display device of claim 16, wherein the first signal-receiving-module comprises a third switch transistor and a fourth switch transistor, a control terminal of the third switch transistor is electrically connected to the one of the plurality of scan lines, a first conductive terminal of the third switch transistor is electrically connected to the one of the plurality of data lines, a second conductive terminal of the third switch transistor is electrically connected to the first node, and the third switch transistor is configured to receive the data signal from the one of the plurality of data lines under the control of the scan signal and transmit the data signal to the first node; and
a control terminal of the fourth switch transistor is electrically connected to the adjustment signal terminal, a first conductive terminal of the fourth switch transistor is electrically connected to the first reference voltage terminal, a second conductive terminal of the fourth switch transistor is electrically connected to the first node, and the fourth switch transistor is configured to be turned on under the control of the adjustment signal terminal to transmit the first reference signal to the first node.

18. The display device of claim 17, wherein the second signal-receiving-module comprises a fifth switch transistor, the maintaining module comprises a sixth switch transistor, a control terminal of the fifth switch transistor is electrically connected to the adjustment signal terminal, a first terminal of the fifth switch transistor is electrically connected to the second reference voltage terminal, and a second terminal of the fifth switch transistor is electrically connected to the fourth node, and the fifth switch transistor is configured to receive the second reference signal from the second reference voltage terminal under the control of the adjustment signal terminal, and transmit the second reference signal to the fourth node;
a control terminal of the sixth switch transistor is electrically connected to the one of the plurality of scan lines, a first terminal of the sixth switch transistor is electrically connected to the second reference voltage terminal, a second conductive terminal of the sixth switch transistor is electrically connected to the fourth node, and the sixth switch transistor is configured to be turned on under the control of the scan signal, to control the second reference voltage terminal to output the second reference signal to the fourth node in the data writing phase, to maintain a voltage of the fourth node.

19. The display device of claim 18, wherein,
in a first time period which is the initialization phase, the first switch transistor, the second switch transistor, the fourth switch transistor, and the fifth switch transistor are turned on, the third switch transistor, the sixth switch transistor, and the driving switch transistor are turned off, and the driving voltage terminal charges the second node to the first potential through the first switch transistor and the second switch transistor; meanwhile, the first reference voltage terminal outputs the first reference signal to the first node through the fourth switch transistor to control the first node to reset to a first reference potential, and the second reference voltage terminal outputs the second reference signal to the fourth node to control the second node to reset to a second reference potential;
in a second time period which is the compensation phase, the second switch transistor, the fourth switch transistor, and the fifth switch transistor are turned on, the first switch transistor, the third switch transistor, and the sixth switch transistor are turned off, the driving switch transistor is turned on under the control of the first node and the second node, the second node discharges to the fourth node through the second switch transistor and the driving switch transistor, the driving switch transistor is turned off in response to the second node dropping from the first potential to the second potential, and the threshold voltage of the driving switch transistor is adjusted to the predetermined value, wherein the second capacitor is configured to maintain a voltage of the second node;
in a third time period which is the data writing phase, the first switch transistor, the second switch transistor, the fourth switch transistor, and the fifth switch transistor are turned off, the third switch transistor and the sixth switch transistor are turned on, the data signal is transmitted to the first node through the third switch transistor, and the second reference signal is transmitted to the fourth node through the sixth switch transistor, wherein the first capacitor is configured to maintain a potential of the first node; and
in a fourth time period which is a light-emitting phase, the second switch transistor, the third switch transistor, the fourth switch transistor, the fifth switch transistor, and the sixth switch transistor are turned off, the first switch transistor is turned on; meanwhile, the data signal controls the driving switch transistor to be turned on, and the driving voltage terminal outputs a driving current to drive the light-emitting module to emit light.

20. The display device of claim 19, wherein the first time period and the second time period are executed in a non-display phase, the third time period and the fourth time period are executed in an image display phase, and the non-display phase is a startup non-display phase.
